(19) United States
(12) Patent Application Publication
(10) Pub. No.: US 2026/0228495 A1
(43) Pub. Date: Aug. 6, 2026

(54) PARAMETER-EFFICIENT MIXTURE OF EXPERTS NEURAL NETWORKS

(71) Applicant: Google LLC, Mountain View, CA (US)

(72) Inventors: Vahab Seyed Mirrokni, Short Hills, NJ (US); Kaiyuan Wang, Newark, CA (US); MohammadHossein Bateni, South Orange, NJ (US); Lin Chen, Jersey City, NJ (US); Gang Fu, Kearny, NJ (US); Kyriakos Axiotis, Brooklyn, NY (US)

(21) Appl. No.: 19/530,222

(22) Filed: Feb. 4, 2026

(30) Foreign Application Priority Data
Feb. 4, 2025 (GR) 20250100084

(51) Int. Cl. G06N 3/045

(52) U.S. Cl. CPC G06N 3/045

(57) ABSTRACT

Methods, systems, and apparatus, including computer programs encoded on a computer storage medium, for performing a machine learning task using a neural network that includes a Mixture of Experts (MoE) subnetwork configured to process an input tensor to generate an output tensor. The MoE Subnetwork includes a set of multiple expert blocks, each configured to process a corresponding partition of the input tensor to generate a corresponding partition of the output tensor.

### CROSS-REFERENCE TO RELATED APPLICATION

This application claims priority to Greek patent application No. 20250100084, filed on Feb. 4, 2025, the disclosure of which is hereby incorporated by reference in its entirety.

### BACKGROUND

This specification relates to performing a machine learning task on a network input using neural networks.

Machine-learning models receive an input and generate an output, e.g., a predicted output, based on the received input. Some machine-learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification describes methods, computer systems, and apparatus, including computer programs encoded on computer storage media, for performing a machine learning task on a network input using a neural network that includes a Mixture of Experts (MoE) subnetwork.

In this specification, a MoE network can refer to a neural network (or subnetwork) that includes multiple expert components and a mixing mechanism that combines contributions from two or more of the expert components to generate an output. Each expert component can include one or more layers (e.g., one or more linear layers and, optionally, one or more non-linear activation functions).

In this specification, a tensor can refer to a multidimensional array of numerical values arranged according to one or more dimensions. The numerical values can be represented in any of a variety of data types, including floating-point formats, integer formats, or other numeric encodings. A tensor can have any rank (e.g., a scalar, a vector, a matrix, or a higher-rank array). For example, a tensor can represent a feature vector, an embedding, a batch of embeddings, an image (e.g., height×width×channels), a video (e.g., frames×height×width×channels), an audio representation (e.g., time×frequency bins), or any intermediate data generated by a neural network. A tensor can be stored in memory in any format, including contiguous or non-contiguous layouts, and can be represented using dense storage or, in some cases, sparse storage (e.g., storing only non-zero elements and corresponding indices).

In particular, the MoE subnetwork includes a set of multiple expert blocks and a shared mixing layer that is shared across the multiple expert blocks. Each expert block includes a respective input block, e.g., including a respective first set of one or more linear layers, and a respective output block, e.g., including a respective second set of one or more linear layers.

The MoE subnetwork receives an input tensor generated from the network input. The system partitions the input tensor into a set of multiple input component tensors. For each respective expert block, the system processes a corresponding one of the input component tensors using a respective input block of the expert block to generate a respective intermediate tensor.

The system uses the shared mixing layer to process a combined intermediate tensor that combines the intermediate tensors to generate a mixed tensor. The system then partitions the mixed tensor into a set of multiple component mixed tensors.

For each respective expert block, the system processes a respective corresponding one of the component mixed tensors using a respective output block of the respective expert block to generate a respective output component tensor, and concatenates the output component tensors to form the output tensor. The system then generates the network output using the output tensor generated by the MoE subnetwork.

The subject matter described in this specification can be implemented in particular implementations so as to realize one or more of the following advantages.

One challenge in achieving high-quality results for machine learning tasks is that many machine learning models, particularly large neural networks, are computationally expensive and require significant hardware resources. For example, a fully connected layer in a neural network typically has a dense weight matrix with d₂×d₁ parameters, where d₁ and d₂ are the input and output dimensions, respectively. When a model contains multiple such layers, the large number of parameters results in substantial computational overhead during both training and inference. This high demand for memory and floating-point operations (FLOPs) can limit the scalability of certain models, making them impractical for deployment on resource-constrained devices. Furthermore, the high demand for FLOPs also increases processing time, making real-time or latency-sensitive applications impractical in certain scenarios. In tasks such as interactive AI systems, autonomous control, or large-scale data processing, excessive computation time can hinder responsiveness and efficiency, preventing deployment in scenarios that require fast decision-making or real-time inference.

To address these issues, the system described in this specification leverages a Mixture of Experts (MoE) architecture to distribute the computational load among multiple expert blocks, thereby improving efficiency. Each expert block handles a portion of the input tensor and generates a portion of the output tensor, allowing for parallel processing and reducing the overall computational burden on a single unit.

In some implementations, the input and output blocks of the expert blocks correspond to a low-rank factorization of a weight matrix of a fully connected layer. That is, the length of the intermediate tensor processed by each expert block is shorter than the length of the input and output tensors. This effectively reduces the parameter count and computational cost associated with the weight matrices while still preserving the expressiveness and representational power of the model.

Compared to conventional MoE networks, which typically use a gating mechanism to route inputs to different experts, the techniques described herein use a shared mixing layer. The mixing layer can be more efficient than the gating mechanisms because it does not require an additional auxiliary network to determine expert assignments. The mixing layer can be a linear layer, which eliminates the need for sampling or softmax computations typically required in gating mechanisms, resulting in lower inference latency and reduced computational cost.

In particular, in some implementations, the mixing layer can be sparsely parameterized, i.e., have a small number of unique non-zero parameters. This further reduces the computational cost and memory requirements associated with the mixing operation in both training and inference, as fewer parameters need to be stored and processed during both training and inference.

In summary, the described techniques achieve an improvement in computer technology by reducing computational resource consumption in large neural network models while maintaining model quality. The high computational cost of fully connected layers and conventional MoE networks is addressed by replacing dense weight matrices with a structured and efficient MoE-based architecture. Specifically, implementations of the described techniques partition input tensors into smaller components, distribute computations across multiple expert blocks, and utilize a sparsely parameterized mixing layer with reduced rank to efficiently combine expert computations. These techniques reduce the number of model parameters, lower memory and bandwidth requirements, and decrease the number of floating-point operations (FLOPs) needed for training and inference.

In addition, the described MoE block architecture can be configured and optimized for a particular set of target hardware and deployment constraints. For example, the number of expert blocks (K) can be selected so that (i) the parameters and intermediate activations for one or more expert blocks fit within an available on-chip or device memory budget (e.g., cache, SRAM, GPU memory, or other constrained memory space), (ii) the workload is partitioned to achieve a desired throughput on the target compute units, and/or (iii) the model generates outputs within a specified latency threshold when executed on the target hardware. In some implementations, the selection of K can be based on specific deployment constraints, including memory footprint, throughput, and latency requirements, such that the partitioning and mixing operations are tailored to the compute and memory characteristics of the deployment platform. By enabling hardware-aware configuration of the expert blocks and mixing layer, computational efficiency is improved while maintaining model quality, enabling faster processing and more scalable deployment of large models, particularly in resource-constrained environments.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an environment for a machine learning system to process an input.

FIG. 2 illustrates an example MoE subnetwork processing an input tensor.

FIG. 3 is a flow diagram of an example process for using an MoE subnetwork to process an input tensor.

FIG. 4 shows a performance comparison of a described model with a benchmark model.

FIG. 5 shows another performance comparison of a described model with a benchmark model.

Like reference numbers and designations in the various drawings indicate like elements.

### DETAILED DESCRIPTION

This specification describes methods, computer systems, and apparatus, including computer programs encoded on computer storage media, for performing a machine learning task on a network input using a neural network that includes a Mixture of Experts (MoE) subnetwork.

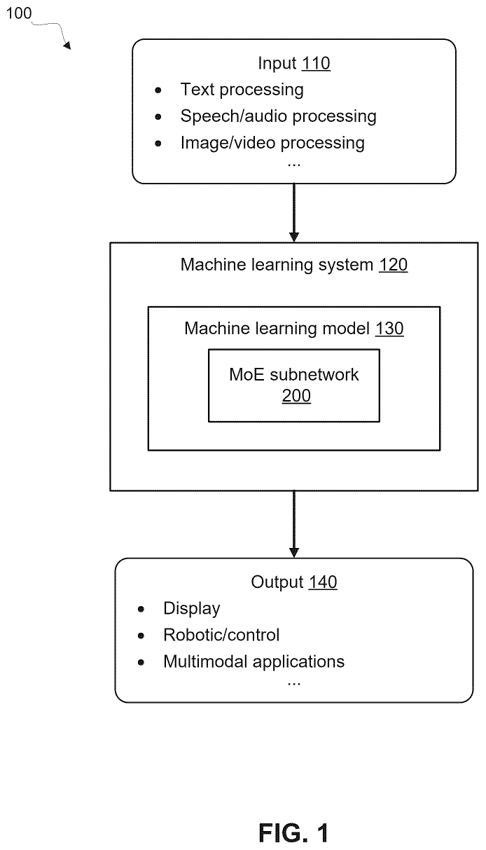

FIG. 1 shows an environment 100 for a machine learning system 120 to process an input 110. The machine learning system 120 can be implemented as computer programs on one or more computers in one or more locations. In some implementations, the machine learning system 120 includes one or more processors, memory, and one or more storage devices that store model parameters and instructions for executing the model.

In the example of FIG. 1, the machine learning system 120 includes (or accesses) a machine learning model 130. The machine learning model 130 includes a Mixture of Experts (MoE) subnetwork 200. In some implementations, the model 130 includes multiple layers or subnetworks, and the MoE subnetwork 200 is integrated within one or more of those layers (e.g., as a replacement for, or as part of, a feed-forward or fully connected layer).

In some implementations, the MoE subnetwork 200 can be used as a modular, parameter-efficient replacement for a standard fully connected layer that would otherwise apply a dense weight matrix W to map an input tensor xᵢₙ to an output tensor yₒᵤₜ. For example, a dense layer could compute yₒᵤₜ=σ(Wxᵢₙ+b), and the MoE subnetwork 200 can be configured to provide a comparable mapping while reducing parameter count and/or computation.

In general, the model 130 may include multiple layers or subnetworks, and the MoE subnetwork 200 can be integrated within one or more of those layers as a replacement for, or as part of, a feed-forward or fully connected layer. For instance, in a Transformer-based architecture, the MoE subnetwork 200 can replace the dense feed-forward blocks that typically follow the multi-head attention layers. In a Vision Transformer (ViT) model, the subnetwork can be utilized to replace linear projection layers or multi-layer perceptron (MLP) heads used for classification. In convolutional neural networks (CNNs), the MoE subnetwork 200 can replace conventional global fully connected layers, e.g., at the end of the feature extraction pipeline. The subnetwork 200 may also be inserted within a residual block, allowing it to perform an expansion or compression of the tensor dimension while maintaining efficiency.

In some implementations, the machine learning system 120 can run locally on a user device. In some implementations, the machine learning system 120 can run on one or more remote servers (e.g., cloud servers), and a user device can transmit the input 110 to the servers and receive the output 140 over a data network. In some implementations, processing can be split between devices, such that earlier preprocessing (e.g., a feature extraction) can be performed on a client device and later processing is performed on a server (or vice versa).

The machine learning system 120 receives the input 110. In some implementations, the input 110 includes text processing input, speech or audio processing input, and/or image/video processing input. The input 110 can be obtained from one or more sources, such as a user interface, a sensor subsystem, a stored dataset, a network stream, or another computer system.

In some implementations, the machine learning system 120 performs preprocessing to convert the input 110 into a network input for the model 130. For example, text can be tokenized into tokens or word pieces; audio can be converted into a sequence of frames or spectral features; and image/video can be converted into pixel tensors or feature maps. The preprocessing can also include normalization, resizing, cropping, filtering, and/or encoding operations. The machine learning system 120 can then generate one or more tensors (e.g., embeddings or feature tensors) for processing by the model 130 and, in some cases, for processing by the MoE subnetwork 200.

The machine learning system 120 processes the input 110 using the machine learning model 130 (including the MoE subnetwork 200) to generate an output 140. In some implementations, the output 140 is provided for presentation on a display, for robotic/control operation, and/or for use by multimodal applications. For example, the output 140 can include a classification score vector, a predicted label, a generated sequence, an embedding, a structured prediction, or control signals.

In some implementations, the machine learning system 120 executes the model 130 in an inference mode to generate the output 140 for new inputs 110. During inference, the system 120 obtains an input 110 (e.g., an input tensor), provides the input 110 to the model 130, and causes the model 130 to generate the output 140 based on a forward pass through one or more layers of the model 130, including the MoE subnetwork 200. In some implementations, the forward pass includes applying one or more embedding layers and/or feature extraction layers to produce an intermediate representation, providing the intermediate representation to the MoE subnetwork 200 (e.g., as a replacement for a dense layer), and generating an MoE-based output representation that is propagated to subsequent layers of the model 130 to produce the output 140.

Before being used for inference, in some implementations, the model 130 is trained by the machine learning system 120 or by another training system. In some implementations, the training system obtains one or more training datasets that include training examples. For example, the training examples can include labeled input-output pairs (e.g., input text paired with a class label, input images paired with object labels, or input feature vectors paired with regression targets), unlabeled data for self-supervised training (e.g., text corpora, image collections, audio streams, or multimodal data), or interaction logs (e.g., click logs or query-document pairs) for ranking or recommendation tasks.

In some implementations, the training system can execute the model 130 on batches of training data to generate predicted outputs, compute one or more training losses based on the predicted outputs, and update parameters of the model 130 based on the losses.

In some implementations, the training losses can include, for example, a cross-entropy loss for classification or next-token prediction, a mean-squared error (MSE) or mean absolute error (MAE) loss for regression, a negative log-likelihood loss for sequence modeling, a contrastive loss (e.g., InfoNCE or triplet loss) for representation learning and embedding models, a pairwise or listwise ranking loss (e.g., hinge loss, logistic pairwise loss, or softmax-based listwise loss) for ranking tasks, or a reconstruction loss for autoencoding or masked modeling objectives. In some implementations, for language-model training, the losses can include a token-level cross-entropy over a vocabulary based on predicted logits, and for masked modeling the loss can be computed over masked positions. In some implementations, for image or multimodal tasks, the loss can include a classification loss, a detection loss, a segmentation loss (e.g., pixelwise cross-entropy), or a combination of multiple task losses. In some implementations, the training system combines multiple losses, e.g., as a weighted sum.

In some implementations, the training system updates parameters of the model 130 using backpropagation through the MoE subnetwork 200 and other layers of the model 130 (e.g., end-to-end training). For example, the training system can compute gradients of the one or more losses with respect to parameters of the MoE subnetwork 200 (including parameters of expert blocks and parameters of the sparsely parameterized mixing layer) and with respect to parameters of upstream and downstream layers, and updates the parameters using an optimization algorithm such as stochastic gradient descent (SGD), Adam, AdamW, RMSProp, or another gradient-based optimizer.

In some implementations, the MoE subnetwork 200 is trained jointly, e.g., via end-to-end training, with other portions of the model 130 during pretraining and/or task-specific training. After end-to-end training, in some implementations, the model 130 can be optionally adapted to a particular downstream task or deployment environment using fine-tuning. In some implementations, fine-tuning can include updating all parameters of the model 130. In other implementations, fine-tuning can be parameter-efficient and update only a subset of parameters, such as updating parameters of the MoE subnetwork 200 while keeping other parameters fixed, or updating only the mixing-layer parameters while keeping expert-block parameters and other model parameters fixed.

The machine learning model 130 can be configured for any of a variety of machine learning tasks. In some implementations, the model 130 is, or includes, a generative language model and/or a multimodal model (e.g., a vision-and-language model).

In some implementations, the task is an image processing task in which the input 110 includes an input image (or video), and the output 140 includes a network output for the input image. Example image processing tasks include image classification (e.g., scores for object categories), image embedding generation (e.g., a numeric embedding of the input image), object detection (e.g., locations of depicted objects), and image segmentation (e.g., per-pixel category assignments). In these examples, the output 140 can be used for display (e.g., overlaying detections on an image), retrieval (e.g., nearest-neighbor search using embeddings), or downstream decision making.

In some implementations, the task is an image generation task in which the input 110 is a conditioning input and the output 140 defines pixel intensity values (or other image data) for a generated image. The conditioning input can include, for example, a text prompt, an image prompt, or other guidance data.

In some implementations, the task is a neural machine translation task in which the input 110 includes a sequence of text in a first language and the output 140 includes a translated sequence of text in a second language. In some cases, the task is multi-lingual machine translation, where the input text includes an identifier for a target language.

In some implementations, the task is automatic code generation. For example, the input 110 includes natural language tokens and the output 140 includes instructions in a programming or markup language, or instructions for controlling an application program to perform a task (e.g., build a data item such as an image or web page).

In some implementations, the task is an audio processing task in which the input 110 includes audio representing a spoken utterance. Example audio tasks include speech recognition (e.g., transcript likelihood scores), hotword detection, and speech classification (e.g., language identification for the utterance). In these implementations, the output 140 can be provided to a display (e.g., captions), to a speech interface, and/or to a downstream application.

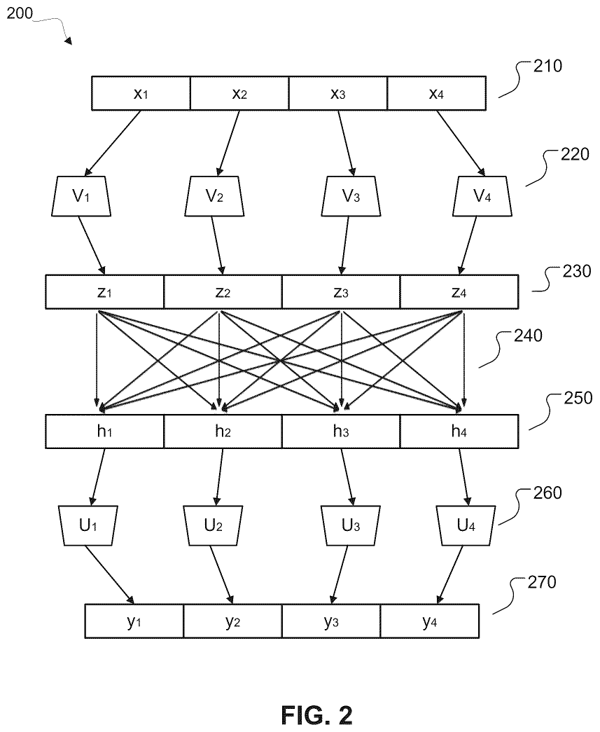

FIG. 2 illustrates an example Mixture-of-Experts (MoE) subnetwork 200 that receives an input tensor 210 and generates an output tensor 270. The MoE subnetwork 200 can be integrated within a machine learning model executed by a computer-implemented system, for example within model 130 of the machine learning system 120 described with reference to FIG. 1. In some cases, the process or a part of the process described below can be performed on a mobile device, such as a smart phone, a tablet, a wearable device, an extended reality (XR) device, or another user device.

The input tensor 210 (also referred to as xᵢₙ) can include any intermediate representation produced by upstream components of the model. For example, xᵢₙ can include a token embedding or hidden state at a position in a text sequence, a representation produced by an attention sublayer in a transformer architecture, or a multimodal embedding produced by combining representations from multiple modalities. In some implementations, the input tensor 210 can include a vector of dimension d₁.

As shown in FIG. 2, the MoE subnetwork 200 can partition the input tensor xᵢₙ into K input component tensors x₁, x₂, . . . , x_{K}. In some implementations, the partitioning is along a feature or channel dimension and is expressed as a block vector

$${x}_{i n} = {[ {x}_{1}^{⊤} {x}_{2}^{⊤} … {x}_{K}^{⊤} ]}^{⊤} ,$$

such that xᵢₙ is formed by concatenating the component vectors. In this case, each xᵢ corresponds to a contiguous segment of elements of xᵢₙ. For example, in an auto-regressive decoder transformer architecture, the input tensor xᵢₙ can represent a single token embedding or a hidden state at a specific position in a text sequence. In this scenario, partitioning the input tensor involves splitting the high-dimensional embedding vector (e.g., of dimension d₁) into K sub-vectors, where each xᵢ corresponds to a contiguous segment of the embedding's elements.

Other implementations may utilize interleaved, strided, or index-mapped partitions to distribute sub-components of the input tensor 210. While four partitions are shown in FIG. 2 for clarity, K can be any integer K≥2, e.g., 2, 6, 8, 16, etc. The selection of K can be based on specific deployment constraints, including memory footprint, throughput, and latency requirements.

For each respective input component tensor xⱼ, the MoE subnetwork 200 applies a corresponding input block 220 to generate an intermediate tensor z; 230. In the example of FIG. 2, each input block 220 is represented by a matrix Vⱼ such that zⱼ=Vⱼxⱼ. Each Vⱼ can be a row-wise block of a block-diagonal matrix V∈ [symbol] ^{Kr×d}^{₁}. In some implementations, each input block 220 can include a single linear layer and may include a bias term. In some other implementations, an input block 220 can include multiple layers, such as two or more linear layers, and/or one or more nonlinear activation functions between layers. Parameters of the input blocks 220 are typically not shared among them. In some implementations, each intermediate tensor zⱼ can have a dimension r that is smaller than the dimension of xⱼ along the dimension of the partitioning to improve parameter efficiency and reduce computation.

The intermediate tensors z₁, . . . , z_{K} can be combined to form a combined intermediate tensor z. In some implementations, the system concatenates the intermediate tensors to form

$$z = {[ {z}_{1}^{⊤} {z}_{2}^{⊤} … {z}_{K}^{⊤} ]}^{⊤} ,$$

such that z∈ [symbol] ^{Kr} when each zⱼ∈ [symbol] ^{r}. In some cases, the MoE subnetwork 200 can apply an optional scaling or gating operation to one or more intermediate tensors prior to combination.

The subnetwork 200 applies a shared mixing layer 240 to the combined intermediate tensor z to generate a mixed tensor h 250. In some implementations, the shared mixing layer 240 includes a linear layer represented by a shared mixing matrix M∈ [symbol] ^{Kr×Kr} such that h=Mz. The mixed tensor h can be partitioned into K component mixed tensors h₁, h₂, . . . , hₖ, for example by splitting h into K contiguous blocks of length r.

In a block-matrix view, the mixing matrix M can be partitioned into a K×K grid of sub-matrices Mᵢⱼ, where each sub-matrix Mᵢⱼ ∈ [symbol] ^{r×r} maps intermediate tensor zⱼ to a contribution for mixed tensor hᵢ. Accordingly, the MoE subnetwork 200 can compute hᵢ=

$${\sum }_{j = 1}^{K} {M}_{i j} {z}_{j} ,$$

enabling cross-block interaction and increased expressivity relative to architectures in which blocks remain independent. To balance expressivity and efficiency, the MoE subnetwork 200 can parameterize the mixing matrix M using various constrained structures for the sub-matrices Mᵢⱼ as described below.

In some implementations, each sub-matrix can be a scaled identity matrix Mᵢⱼ=aᵢⱼlᵣ, where lᵣ is an r×r identity matrix and the scalars aᵢⱼ can be entries of a matrix A∈ [symbol] ^{K×K}. This parameterization can include K² scalar parameters given by the entries of A and can enable each output block to incorporate scaled contributions from each intermediate tensor while maintaining a structured and computationally efficient mixing operation.

In some implementations, each sub-matrix Mᵢⱼ can be diagonal, for example Mᵢⱼ=diag(bᵢⱼ) where bᵢⱼ∈ [symbol] ^{r}, which can provide coordinate-wise mixing while remaining more efficient than a dense r×r sub-matrix. In this case, the mixing matrix M has no more than rK² non-zero weight parameters.

In some implementations, each sub-matrix Mᵢⱼ can be the sum of a diagonal matrix and a rank-one matrix, for example

$${M}_{i j} = diag ( {c}_{i j} ) + {α}_{i j} {β}_{ij}^{⊤} ,$$

where cᵢⱼ, αᵢⱼ,βᵢⱼ∈ [symbol] ^{r}, which can provide increased expressivity relative to diagonal mixing while remaining more parameter-efficient than dense mixing. In this case, the mixing matrix M has no more than 3rK² non-zero unique weight parameters.

In some other implementations, one or more sub-matrices Mᵢⱼ can be implemented using additional structures, such as a low-rank matrix of rank s<<r, a block-diagonal matrix with smaller sub-blocks, or a masked dense matrix having a predetermined sparsity pattern.

For each component mixed tensor hᵢ, the MoE subnetwork 200 applies a corresponding output block Uᵢ 260 to hᵢ to generate an output component tensor yᵢ, i.e., yᵢ=Uᵢhᵢ. Substituting the expressions for hᵢ yields

$${y}_{i} = {U}_{i} ( {\sum }_{j = 1}^{K} {M}_{ij} {z}_{j} ) = {\sum }_{j = 1}^{K} {U}_{i} {M}_{i j} {z}_{j} = {\sum }_{j = 1}^{K} {U}_{i} {M}_{i j} {V}_{j} {x}_{j} .$$

Accordingly, for each ordered pair (i,j), the composite mapping UᵢMᵢⱼ Vⱼ can map the input block xⱼ to a contribution for the output component tensor yᵢ, and each output component tensor yᵢ can be formed as an aggregation of contributions from multiple input component tensors via respective composite mappings.

In some implementations, each output block 260 can include a single linear layer and may include a bias term. In other implementations, each output block 260 can include multiple layers and may include one or more non-linear activation functions, normalization operations, and/or dropout. In general, the layers of the output blocks 260 are not shared between the blocks.

The output tensor 270 (also referred to as yₒᵤₜ) can be formed by combining the output component tensors y₁, y₂, . . . , y_{K}. In some implementations, the output components can be concatenated such that

$${y}_{out} = {[ \begin{matrix}{y}_{1}^{⊤} & {y}_{2}^{⊤} & … & {y}_{K}^{⊤}\end{matrix} ]}^{⊤} .$$

In some implementations, the output dimension of yᵢ can match the dimension of xᵢ so that the MoE subnetwork 200 can be inserted as a replacement within a residual block. In other implementations, the output dimension can differ from the corresponding input dimension, for example, to implement an expansion or compression.

In some implementations, computations performed by the K input blocks 220 can be parallelized to maximize training and inference efficiency, for example using multiple kernels, and/or multi-threaded executions. Similarly, computations performed by the K output blocks 260 can be parallelized. In some implementations, the shared mixing operation can be implemented using kernels that exploit the structure of the mixing matrix M (e.g., as scaled identity or diagonal blocks) to reduce memory bandwidth and reduce multiply-accumulate operations relative to dense mixing. In some implementations, different expert blocks can be mapped to different compute units, such as different GPU thread blocks, processor cores, or devices, while the shared mixing layer remains shared in parameterization.

The output tensor 270 can be provided to downstream components of the model to generate a network output for a task. For example, in a language modeling task, the output tensor 270 can be used to compute a score distribution over a vocabulary for next-token prediction. In a vision task, the output tensor 270 can be used to compute class logits, bounding boxes, and/or segmentation masks. In translation and/or code generation tasks, the output tensor 270 can be used to compute a probability distribution over next symbols or tokens conditioned on a context.

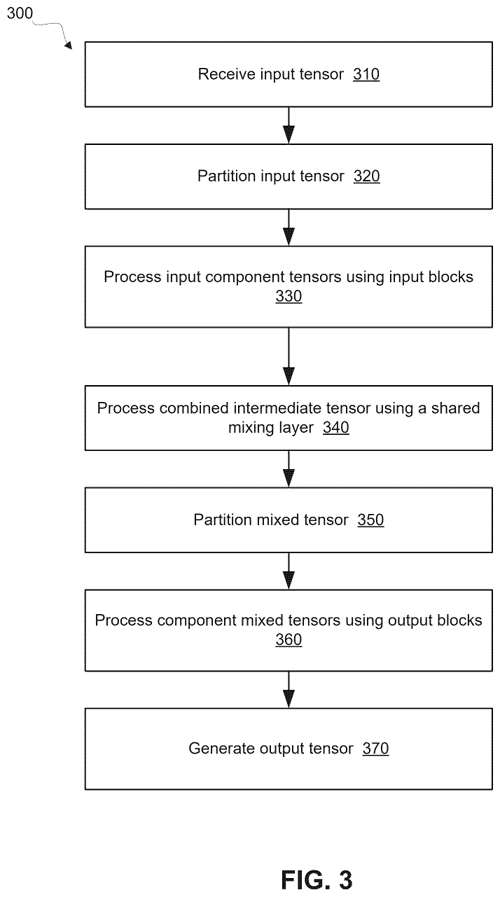

FIG. 3 is a flow diagram of an example process 300 for using a neural network to process a network input to generate a network output. For convenience, the process 300 will be described as being performed by a system of one or more computers located in one or more locations. For example, a computer-implemented system, e.g., the machine learning system 120 depicted in FIG. 1, appropriately programmed in accordance with this specification, can perform the process 300.

At 310, the system receives an input tensor generated from the network input. In some implementations, the network input includes an input token sequence, and the system processes the input token sequence using one or more attention layers of the neural network to generate a sequence of attended token embeddings. In these implementations, the input tensor can include one of the attended token embeddings at a particular position in the sequence. In some implementations, the input tensor can include a token embedding for the token at the particular position.

In some implementations, the neural network operates in an auto-regressive generation mode. In these implementations, at a given generation step, the network input can include a single token corresponding to the most recently generated token or a small set of most recent tokens within a sliding context window. The system can generate an embedding for that token and compute an attended token embedding using one or more attention layers, often utilizing cached key/value tensors for previously generated tokens. In these implementations, the input tensor received at 310 can include the attended embedding of the most recently generated token, or the embedding for each token in the sliding window, which is then processed by the MoE subnetwork as described herein.

At 320, the system partitions the input tensor into a set of multiple input component tensors. In some implementations, the input tensor can be a vector, and partitioning includes splitting the vector into multiple sub-vectors. In some implementations, each sub-vector includes a contiguous segment of elements of the vector. In other implementations, the system uses a non-contiguous partitioning scheme, such as interleaved, strided, or index-mapped partitioning.

At 330, for each respective expert block in a set of multiple expert blocks, the system processes a corresponding input component tensor using a respective input block of the expert block to generate a respective intermediate tensor. In some implementations, each input block includes a respective set of one or more linear layers that are not shared between the multiple expert blocks, and, in some implementations, each input block includes a single linear layer. In some implementations, the length of each intermediate tensor along a dimension of the partitioning is smaller than the length of the respective input component tensor along the dimension of the partitioning, for example, to improve parameter efficiency. In some implementations, computations for the respective input blocks are performed in parallel across the set of multiple expert blocks.

At 340, the system combines the intermediate tensors to generate a combined intermediate tensor, and processes the combined intermediate tensor using a shared mixing layer to generate a mixed tensor. The shared mixing layer is shared between the multiple expert blocks and comprises a weight matrix. In some implementations, the weight matrix has a size based on the number of expert blocks.

In some implementations, the shared mixing layer is parameterized to improve parameter efficiency while maintaining expressivity. For example, in some implementations, each sub-matrix of the weight matrix is a scaled identity matrix, and the weight matrix has no more than K² non-zero unique weight parameters. In another implementation, each sub-matrix is a diagonal matrix, and the weight matrix has no more than K²r non-zero weight parameters. In another implementation, each sub-matrix is a sum of a diagonal matrix and a rank-one matrix, and the weight matrix has no more than 3K²r non-zero unique weight parameters.

At 350, the system partitions the mixed tensor into a set of multiple component mixed tensors. In some implementations, each component mixed tensor corresponds to a respective expert block.

At 360, for each respective expert block, the system processes a respective corresponding component mixed tensor using a respective output block of the expert block to generate a respective output component tensor. In some implementations, each output block includes a respective set of one or more linear layers that are not shared between the multiple expert blocks, and, in some implementations, each output block comprises a single linear layer.

In some implementations, computations for the respective output blocks are performed in parallel across the set of multiple expert blocks.

At 370, the system combines the output component tensors to form an output tensor and generates the network output based on the output tensor. In some implementations, the output tensor includes an updated embedding of the token at the particular position in the input token sequence. In some implementations, the system generates a sequence of updated token embeddings from the sequence of attended token embeddings, where the updated token embedding at the particular position is the output tensor generated by the MoE subnetwork, and generates the network output using the updated token embedding sequence. For example, the network output can define a score distribution over a set of possible tokens for a next token for the input token sequence.

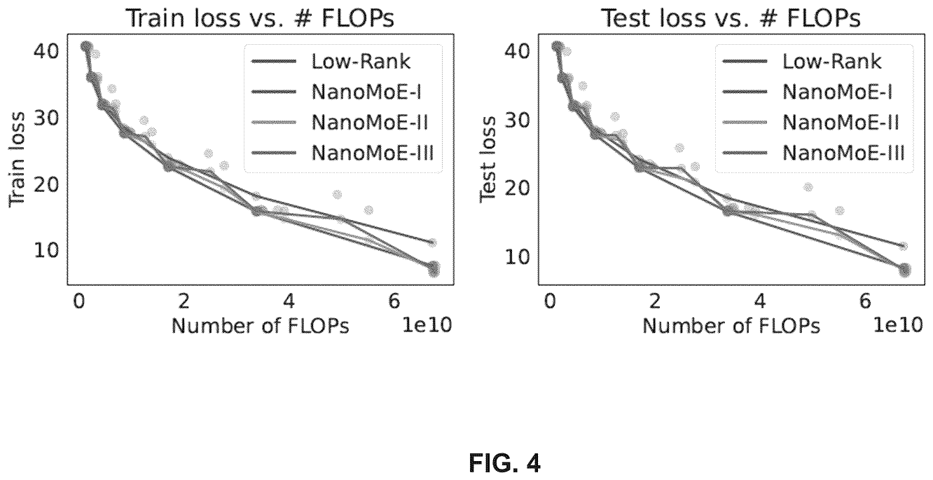

FIG. 4 shows a performance comparison of a described model with a benchmark model. Specifically, FIG. 4 illustrates a comparison of training loss and test loss versus the number of floating-point operations (FLOPs) for the models described above and a low-rank factorization benchmark.

In the experimental results shown in FIG. 4, the performance of NanoMoE-I, NanoMoE-II, and NanoMoE-III as the MoE subnetwork is evaluated against standard low-rank factorization using the first fully connected layer of an OPT-13B model. NanoMoE-I parameterizes the mixing layer M using K×K parameters where each sub-matrix is a scaled identity matrix (Mᵢⱼ=aᵢⱼlᵣ), offering the most streamlined approach with minimal parameter overhead. NanoMoE-II employs K²r parameters to define M as a grid of diagonal sub-matrices, providing coordinate-wise mixing across expert blocks. NanoMoE-III utilizes 3K²r parameters where each sub-matrix is the sum of a diagonal matrix and a rank-one matrix, serving as a general case that offers the highest representational flexibility among the variants.

As depicted by the loss curves, for a fixed FLOP budget, the NanoMoE variants consistently outperform the low-rank factorization benchmark in both training and test metrics. This superior performance validates the enhanced computational efficiency of the framework, as the modular approach achieves lower loss levels even at lower FLOP counts. Similar trends are observed on the AG News classification dataset, where the performance gap is even more pronounced, and NanoMoE-I achieves the best overall performance in terms of loss.

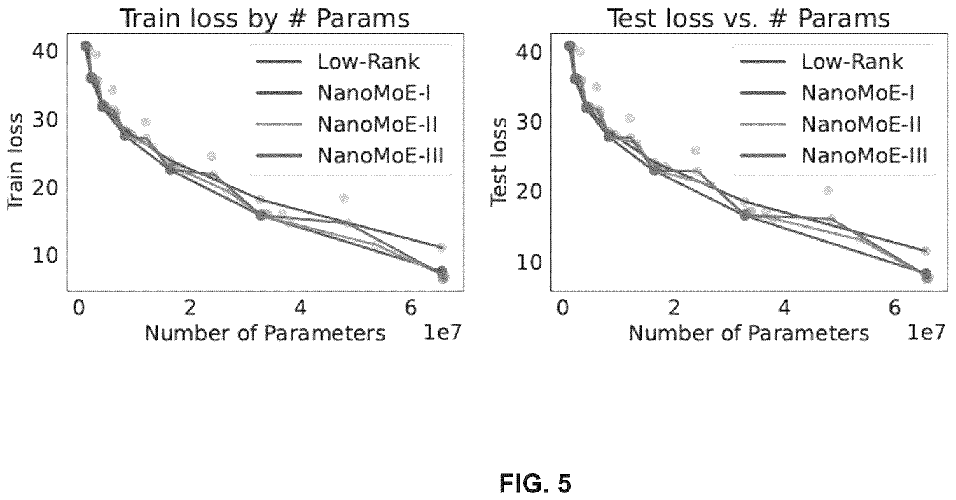

FIG. 5 illustrates a comparison of training loss and test loss versus the number of parameters for Low-Rank Factorization and the three NanoMoE variants. The charts plot the training loss in FIG. 5 (a) and the test loss in FIG. 5 (b).

As shown in the plots, for any fixed parameter budget, the NanoMoE variants consistently achieve superior model quality, represented by lower training and test losses, compared to the Low-Rank Factorization benchmark. These results confirm the enhanced parameter efficiency of the NanoMoE framework, particularly in its ability to leverage higher representational rank with minimal increases in total parameter count.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method for using a neural network to process a network input to generate a network output, wherein the neural network comprises a Mixture of Experts (MoE) subnetwork, the method comprising:
receiving, as an input to the MoE subnetwork, an input tensor generated from the network input;
processing the input tensor using the MoE subnetwork to generate, as an output of the MoE subnetwork, an output tensor, wherein the MoE subnetwork comprises a set of multiple expert blocks, the processing comprising:
partitioning the input tensor into a set of multiple input component tensors;
for each respective expert block in the set of multiple expert blocks, processing a corresponding one of the input component tensors using a respective input block of the respective expert block to generate a respective intermediate tensor;
processing using a shared mixing layer that is shared between the multiple expert blocks, a combined intermediate tensor that combines the intermediate tensors generated by the input blocks of the set of expert blocks to generate a mixed tensor;
partitioning the mixed tensor into a set of multiple component mixed tensors;
for each respective expert block in the set of multiple expert blocks, processing a respective corresponding one of the component mixed tensors using a respective output block of the respective expert block to generate a respective output component tensor; and
concatenating the output component tensors generated by the output blocks of the set of expert blocks to form the output tensor; and
generating the network output based on the output tensor.

2. The method of claim 1, wherein the input tensor is a vector, and partitioning the input tensor comprises partitioning the vector into a set of sub-vectors, each sub-vector containing a contiguous segment of elements of the vector.

3. The method of claim 1, wherein the respective input block of each expert block comprises a respective set of one or more linear layers that are not shared between the multiple expert blocks.

4. The method of claim 3, wherein each respective input block comprises a single linear layer.

5. The method of claim 1, wherein the respective output block of each expert block comprises a respective set of one or more linear layers that are not shared between the multiple expert blocks.

6. The method of claim 5, wherein each respective output block comprises a single linear layer.

7. The method of claim 1, wherein the combined intermediate tensor is formed by concatenating the intermediate tensors generated by the input blocks of the set of expert blocks.

8. The method of claim 1, wherein for each expert block, a length of the respective intermediate tensor is smaller than both (i) a length of the respective input component tensor and (ii) a length of the respective output component tensor along the dimension of the partitioning.

9. The method of claim 1, wherein the shared mixing layer comprises a linear layer with a weight matrix having a size of Kr×Kr, where K is the number of the set of expert blocks, and r is the length of each intermediate tensor.

10. The method of claim 9, wherein the weight matrix of the shared mixing layer has no more than K² non-zero unique weight parameters.

11. The method of claim 10, wherein the weight matrix is parameterized as a K×K grid of sub-matrices, and each sub-matrix is a scaled identity matrix of size r×r.

12. The method of claim 9, wherein the weight matrix of the shared mixing layer has no more than K²r non-zero weight parameters.

13. The method of claim 12, wherein the weight matrix of the shared mixing layer is parameterized as a K×K grid sub-matrices, and each sub-matrix is a diagonal matrix of size r×r.

14. The method of claim 9, wherein the weight matrix of the shared mixing layer has no more than 3K²r non-zero unique weight parameters.

15. The method of claim 14, wherein the weight matrix of the shared mixing layer is parameterized as a K×K grid of sub-matrices, and each sub-matrix is a sum of a diagonal matrix and a rank-one matrix.

16. The method of claim 1, wherein processing the input component tensors using the input blocks to generate the intermediate tensors is performed in parallel across the set of expert blocks.

17. The method of claim 1, wherein processing the component mixed tensors using the output blocks to generate the output component tensors is performed in parallel across the set of expert blocks.

18. The method of claim 1, wherein processing the input tensor using the MoE is performed on a mobile device.

19. A system comprising:
one or more computers; and
one or more storage devices storing instructions that when executed by the one or more computers, cause the one or more computers to perform operations processing a network input to generate a network output, wherein the neural network comprises a Mixture of Experts (MoE) subnetwork, the operations comprising:
receiving, as an input to the MoE subnetwork, an input tensor generated from the network input;
processing the input tensor using the MoE subnetwork to generate, as an output of the MoE subnetwork, an output tensor, wherein the MoE subnetwork comprises a set of multiple expert blocks, the processing comprising:
partitioning the input tensor into a set of multiple input component tensors;
for each respective expert block in the set of multiple expert blocks, processing a corresponding one of the input component tensors using a respective input block of the respective expert block to generate a respective intermediate tensor;
processing using a shared mixing layer that is shared between the multiple expert blocks, a combined intermediate tensor that combines the intermediate tensors generated by the input blocks of the set of expert blocks to generate a mixed tensor;
partitioning the mixed tensor into a set of multiple component mixed tensors;
for each respective expert block in the set of multiple expert blocks, processing a respective corresponding one of the component mixed tensors using a respective output block of the respective expert block to generate a respective output component tensor; and
concatenating the output component tensors generated by the output blocks of the set of expert blocks to form the output tensor; and
generating the network output based on the output tensor.

20. One or more computer-readable storage media storing instructions that, when executed by one or more computers, cause the one or more computers to perform operations processing a network input to generate a network output, wherein the neural network comprises a Mixture of Experts (MoE) subnetwork, the operations comprising:
receiving, as an input to the MoE subnetwork, an input tensor generated from the network input;
processing the input tensor using the MoE subnetwork to generate, as an output of the MoE subnetwork, an output tensor, wherein the MoE subnetwork comprises a set of multiple expert blocks, the processing comprising:
partitioning the input tensor into a set of multiple input component tensors;
for each respective expert block in the set of multiple expert blocks, processing a corresponding one of the input component tensors using a respective input block of the respective expert block to generate a respective intermediate tensor;
processing using a shared mixing layer that is shared between the multiple expert blocks, a combined intermediate tensor that combines the intermediate tensors generated by the input blocks of the set of expert blocks to generate a mixed tensor;
partitioning the mixed tensor into a set of multiple component mixed tensors;
for each respective expert block in the set of multiple expert blocks, processing a respective corresponding one of the component mixed tensors using a respective output block of the respective expert block to generate a respective output component tensor; and
concatenating the output component tensors generated by the output blocks of the set of expert blocks to form the output tensor; and
generating the network output based on the output tensor.
